(19) United States
(12) Patent Application Publication
(10) Pub. No.: US 2026/0343148 A1
(43) Pub. Date: Oct. 29, 2026

(54) SELECTIVE AUDIO STREAMING FOR DUAL EARBUD SETUP

(71) Applicant: QUALCOMM Incorporated, San Diego, CA (US)

(72) Inventors: Tanuj BORDOLOI, Tezpur-Sonitpur (IN); Olk IDAPALAPATI, Hyderabad (IN); Lakshmi Praneeth Reddy CHALLA, Hyderabad (IN)

(21) Appl. No.: 19/191,364

(22) Filed: Apr. 28, 2025

(51) Int. Cl. H04R 3/12; G06F 3/0482; G06F 3/0484; G06F 3/16; H04R 1/10

(52) U.S. Cl. CPC H04R 3/12; G06F 3/0482; G06F 3/0484; G06F 3/165; G06F 3/167; H04R 1/1016; H04R 1/1041; H04R 2420/07; H04R 2430/01

(57) ABSTRACT

Aspects relate to selective audio streaming for a dual earbud setup. A device includes one or more memories that store a media content and one or more processors coupled to the one or more memories. The one or more processors stream a first audio associated with the media content on a pair of linked earbuds. The pair of linked earbuds includes a first earbud and a second earbud. The one or more processors receive an audio stream event related to a second audio. The one or more processors interrupt the stream of the first audio on the second earbud based on the reception of the audio stream event, and stream the second audio exclusively on the second earbud.

### BACKGROUND

### Field of the Disclosure

The present disclosure relates generally to audio streaming, and, more particularly, to audio streaming in dual earbud setup.

### Description of Related Art

Wireless earphones are compact audio hearing devices configured to be worn by a listener. These earphones can be worn over the ear, on the ear, or in the ear, enabling the listener to listen to music, attend phone calls, or interact with a digital assistant without using a physical cable to connect with an audio source (such as mobile phone, laptop, or portable media player). Unlike traditional wired earphones that rely on a direct wired connection with the audio source through a physical connector, wireless earphones utilize radio frequency-based techniques (such as Bluetooth®) for streaming audio from the audio source or interacting with the audio source.

A wireless earphone may have two individual earpieces (such as a left earpiece or a right earpiece) that operate in a synchronized manner to deliver an immersive listening experience to the listener. Such dual earpiece setup can utilize multiple audio channels (for example, corresponding to the left earpiece and the right earpiece) to enhance spatial perception and provide a more natural sense of sound. When both earpieces are worn, each earpiece outputs the same audio in a coordinated manner. However, in scenarios where the two earpieces are shared between two different listeners, each using one earpiece, mirroring of audio on both earpieces may lead to unintended disclosure of private or sensitive information, such as during phone calls or voice assistant interactions.

### SUMMARY

Aspects of the disclosure provides a device. The device includes one or more memories configured to store a media content. The device further includes one or more processors coupled to the one or more memories. The one or more processors are individually or collectively configured to stream a first audio associated with the media content on a pair of linked earbuds. The pair of linked earbuds comprises a first earbud and a second earbud. The one or more processors are individually or collectively configured to receive an audio stream event related to a second audio. The one or more processors are individually or collectively configured to interrupt the stream of the first audio on the second earbud based on the reception of the audio stream event and stream the second audio exclusively on the second earbud.

In certain aspects, an audio output device is provided. The audio output device includes a pair of linked earbuds comprising a first earbud and a second earbud. The first earbud is configured to receive a first audio and output the first audio. The second earbud is configured to receive the first audio as received at the first earbud and output the first audio in synchronization with the output of the first audio from the first earbud. The second earbud is configured to receive a second audio and output the second audio in parallel to the output of the first audio from the first earbud.

In certain aspects, a method for audio playback is disclosed. The method includes streaming a first audio on a pair of linked earbuds, the pair of linked earbuds comprising a first earbud and a second earbud. The method includes receiving an audio stream event related to a second audio and interrupting the streaming of the first audio on the second earbud based on the reception of the audio stream event. The method includes streaming the second audio exclusively on the second earbud while the first earbud and the second earbud are worn.

### BRIEF DESCRIPTION OF THE DRAWINGS

Various aspects of the present disclosure are illustrated by way of example, and not limited by the appended figures, in which like references indicate similar elements:

FIG. 1 is a diagram that illustrates two users each wearing one earbud from a pair of linked earbuds, in accordance with certain aspects of the present disclosure;

FIG. 2 is a block diagram of an example implementation of a device that is operable for selective audio streaming using a pair of linked earbuds, in accordance with certain aspects of the present disclosure.

FIG. 3 is a block diagram that illustrates a pair of earbuds and a charging case, in accordance with certain aspects of the present disclosure;

FIG. 4 is a block diagram that illustrates a Graphical User Interface (GUI) rendered on a display of a device for gesture-based control, in accordance with certain aspects of the present disclosure;

FIG. 5 is a block diagram that illustrates a GUI rendered on a display of a device to present an audio output selection menu for selective audio streaming, in accordance with certain aspects of the present disclosure;

FIG. 6 is a block diagram that illustrates an example scenario depicting selective audio streaming in a dual earbud setup, in accordance with certain aspects of the present disclosure;

FIG. 7 is a block diagram that illustrates a GUI rendered on a display of a device for volume control, in accordance with certain aspects of the present disclosure;

FIG. 8 is a flowchart that illustrates a method (e.g., a process) for selective audio streaming in a dual earbud setup, in accordance with certain aspects of the present disclosure;

FIG. 9 is a flowchart that illustrates a method (e.g., a process) for managing selective audio streaming in a dual earbud setup, in accordance with certain aspects of the present disclosure; and

FIG. 10 is a flowchart that illustrates a method (e.g., a process) for managing independent volume control on a pair of linked earbuds, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and a method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, any magnetic storage devices, combinations of the aforementioned types of computer-readable media, or any medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and any suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Wireless earphones (such as a pair of linked earbuds) can be worn over the ear, on the ear, or in the ear, enabling a listener to listen to music, attend phone calls, or interact with a digital assistant without using a physical cable to connect with an audio source (such as a mobile phone, a laptop, or a portable media player). Such dual earbuds have gained popularity due to their compact form factor, and wireless connectivity features. These earbuds function by streaming audio from connected devices such as smartphones, tablets, or computers, using radio frequency-based techniques (such as Bluetooth®). Conventionally, if both the earbuds are worn, the earbuds stream the same audio in synchronization. In certain scenarios where the pair of linked earbuds is shared between two listeners, each using one earbud, synchronized streaming of the same audio on both earbuds can lead to privacy concerns. For example, in a scenario where two listeners share the pair of linked earbuds to listen to music, both earbuds receive the same audio stream. However, this may become problematic if an incoming call is received while both listeners are listening to music. Answering the call with both earbuds active can inadvertently expose private conversations to both listeners, leading to discomfort or privacy breaches. Furthermore, conventional voice command functionalities for accepting calls typically activate both earbuds (when both earbuds are worn) without offering an option to select only one earbud, thereby limiting user control and convenience.

To address aforementioned limitations, along with inefficiencies that affect user privacy and comfort, various aspects of the present disclosure provide a selective audio streaming mechanism for a dual earbud setup. In many aspects, the proposed solution provides a device comprising one or more memories configured to store a media content. The device may also include one or more processors coupled to the one or more memories to enable selective streaming of audio on a pair of linked earbuds.

In various aspects, the device may be configured to stream a first audio (e.g., music) associated with the media content on the pair of linked earbuds. While the device is streaming the first audio, the device may receive an audio stream event (e.g., an incoming call) related to a second audio. In such a scenario, the device may interrupt the stream of the first audio on the second earbud based on the reception of the audio stream event and stream the second audio (for example, a voice activity associated with the incoming call event) exclusively on the second earbud. By selectively streaming audio content to individual earbuds based on contextual events, user privacy and listening comfort in shared earbud scenarios can be enhanced. Thus, unintended exposure of sensitive or private audio, such as phone call conversations or voice assistant responses, to unintended listeners, sharing the pair of linked earbuds, may be prevented.

In various aspects, the device may be configured to concurrently stream distinct audio content associated with different audio stream events to each of the pair of linked earbuds. For example, the device may concurrently stream the first audio on the first earbud and the second audio on the second earbud such that the shared listening experience of both listeners is not disrupted. For example, during an incoming voice call, one earbud can seamlessly switch to the incoming voice call while the remaining earbud, also worn, can continue streaming original audio content (such as music).

In more aspects, the device may incorporate user-friendly interfaces, such as Graphical User Interfaces (GUIs) and voice assistants, to receive an input for a selection of the second earbud to stream the second audio. In various aspects, the device may also support one or more user-friendly features to enhance flexibility and control during audio streaming. For example, the device may provide an option to transfer the stream of the second audio from the second earbud to the first earbud. This may be beneficial in scenarios where the primary listener switches earbuds or changes preference to receive the second audio on the first earbud. Additionally, the device may enable independent volume control for the first earbud and the second earbud, allowing listeners to adjust audio levels separately.

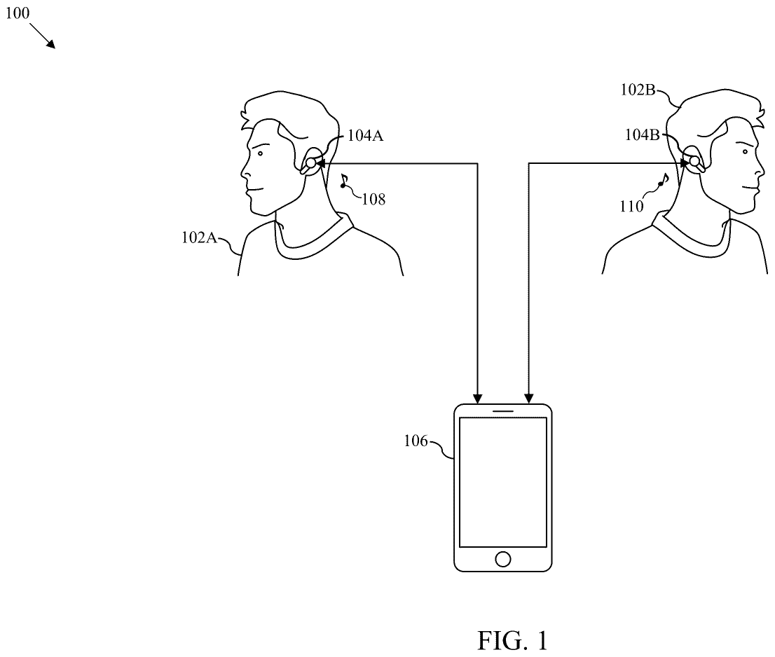

FIG. 1 is a diagram 100 that illustrates two users each wearing one earbud from a pair of linked earbuds, in accordance with certain aspects of the present disclosure. In FIG. 1, there is shown a first user 102A wearing a first earbud 104A (e.g., a left earbud) and a second user 102B wearing a second earbud 104B (e.g., a right earbud). The first earbud 104A and the second earbud 104B are components of a pair of linked earbuds (hereinafter, designated and referred to as “pair of earbuds 104A, 104B”) that collectively form an audio output device. The pair of earbuds 104A, 104B may be wirelessly coupled to a device 106 (such as a user equipment “UE”).

In various aspects, each of the first earbud 104A and the second earbud 104B may be configured to be worn individually in or around a single ear. In other words, the pair of earbuds 104A, 104B may correspond to linked wireless earbuds that are physically unconnected and independently wearable, thereby enabling one earbud from the pair of earbuds 104A, 104B to be worn by the first user 102A and the remaining earbud from the pair of earbuds 104A, 104B to be worn by the second user 102B. Each of the first earbud 104A and the second earbud 104B may be configured as an in-ear earbud, behind-the-ear earbud, or earhook-style earbud. For illustrative purposes, the pair of earbuds 104A, 104B is depicted as in-ear earbud; however, the scope of the disclosure may not be limited to it.

The pair of earbuds 104A, 104B may be configured to operate in cooperation and may be individually controlled or dynamically synchronized by the device 106. Examples of the device 106 may include, but are not limited to, a smartphone, a tablet, a laptop, a smartwatch, smart glasses, or any portable device that can be coupled to the pair of earbuds 104A, 104B for audio streaming. The wireless connection between the pair of earbuds 104A, 104B and the device 106 may be established via Bluetooth®, Wireless Fidelity (Wi-Fi®), or similar short-range wireless protocols. In many aspects, the device 106 may include one or more processors and one or more memories for storing media content and executing audio control logic for the pair of earbuds 104A, 104B.

The device 106 may be configured to stream a first audio 108 (e.g., a song, podcast, or a soundtrack of a video) to both the first earbud 104A and the second earbud 104B. The first audio 108 may be derived from a single audio source associated with media content stored locally on the device 106 or streamed remotely from a server. As used herein, “streaming the first audio 108” may refer to transmitting encoded audio data packets from the device 106 over a wireless communication link to each of the first earbud 104A and the second earbud 104B in the pair of earbuds 104A, 104B. In one example, the device 106 may transmit the same audio packet to both earbuds 104A, 104B in parallel. In more examples, the device 106 may transmit distinct but temporally aligned left-channel and right-channel audio packets of the first audio 108 to the first earbud 104A and the second earbud 104B, respectively, when the first audio 108 is encoded as a stereo stream.

Each of the first earbud 104A and the second earbud 104B may be configured to receive the first audio 108 from the device 106. In an example, each of the first earbud 104A and the second earbud 104B may include a wireless transceiver, a memory buffer, and a signal processing module configured to decode and output the first audio 108 in synchronization. In stereo playback scenarios, the first earbud 104A may receive and output a left-channel of the first audio 108 and the second earbud 104B may receive and output a right-channel of the first audio 108 in synchronization with the output of the left-channel of the first audio 108 from the first earbud 104A. In mono playback scenarios, both the first earbud 104A and the second earbud 104B may receive and output the same channel of the first audio 108 in synchronization.

While streaming the first audio 108 to both the first earbud 104A and the second earbud 104B, the device 106 may receive (or detect) an audio stream event related to a second audio 110. The second audio 110 is not a different channel, version, or segment of the first audio 108, but instead represents a separate and independently triggered stream that is contextually and functionally distinct from the first audio 108. Examples of the audio stream event may include, but are not limited to, an incoming phone call, a notification (such as a calendar reminder or alarm), a voice assistant prompt, or a real-time voice message.

In response to receiving the audio stream event, the device 106 may be configured to interrupt the stream of the first audio 108 on the second earbud 104B and instead stream the second audio 110 exclusively on the second earbud 104B. For example, the first user 102A and the second user 102B may be listening together to a podcast (e.g., representing the first audio 108) via the pair of earbuds 104A, 104B, when the device 106 receives an incoming call (e.g., representing the audio stream event). In such a scenario, the device 106 interrupts the stream of the podcast on the second earbud 104B and streams an incoming voice activity (e.g., representing the second audio 110) associated with the incoming call on the second earbud 104B exclusively.

In one aspect, the first user 102A may continue listening to the podcast uninterrupted via the first earbud 104A. Thus, the device 106 can concurrently stream the first audio 108 on the first earbud 104A and the second audio 110 on the second earbud 104B. In other words, the second earbud 104B may output the second audio 110 in parallel to the output of the first audio 108 from the first earbud 104A. In further aspects, the first user 102A may choose to pause the podcast while keeping the first earbud 104A worn. In such a scenario, the device 106 may stream the second audio 110 exclusively on the second earbud 104B while the second earbud 104B and the first earbud 104A are worn.

The selective audio streaming functionality described herein thus supports audio delivery to users sharing the pair of earbuds 104A, 104B. This configuration may enable concurrent output of the first audio 108 on the first earbud 104A and the second audio 110 on the second earbud 104B. The pair of earbuds 104A, 104B thereby allows for a shared audio delivery mode and a private audio delivery mode, enhancing user flexibility during co-usage of a single audio output system. As a result, unintended exposure of sensitive or private audio, such as phone call conversations or voice assistant responses, to unintended listeners may be prevented.

In one or more aspects, in order to enable the private audio delivery mode, where the second audio 110 is exclusively streamed on the second earbud 104B while the first earbud 104A is also worn, the device 106 can perform a variety of processing operations. In response to receiving the audio stream event associated with the second audio 110, the device 106 may temporarily modify an audio output configuration. In an example, the device 106 may pause or mute (e.g., interrupt) the first audio 108 on the second earbud 104B while maintaining uninterrupted playback of the first audio 108 on the first earbud 104A. In more examples, when the first audio 108 is originally encoded as a stereo signal, the device 106 may switch the audio playback mode to mono for the first earbud 104A, ensuring that no audio information is lost due to the exclusion of a stereo channel. Additionally or optionally, the device 106 may dynamically reallocate audio routing, assign stream priorities, or buffer playback states to preserve playback continuity. Further, in some aspects, the device 106 may independently control gain, playback speed, or audio equalization parameters of each of the first earbud 104A and the second earbud 104B to enable an optimal listening experience for both the first user 102A and the second user 102B under diverging playback contexts. For example, when a voice assistant response is delivered as the second audio 110 to the second earbud 104B, the device 106 may simultaneously lower the gain on the first earbud 104A to reduce distraction.

In many aspects, the device 106 may be configured to resume the stream of the first audio 108 on the second earbud 104B upon a termination of the audio stream event. Continuing the above example, once the call is ended or terminated, the device 106 may resume the stream of the podcast on the second earbud 104B. As such, an output of the first audio 108 from the second earbud 104B re-synchronizes with an output of the first audio 108 from the first earbud 104A for a consistent listening experience.

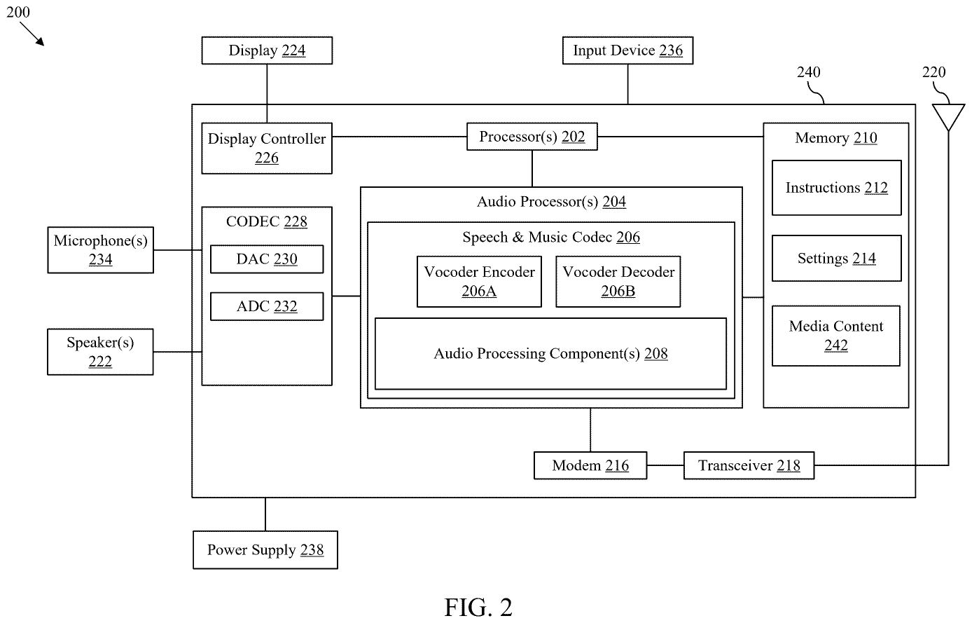

FIG. 2 is a block diagram of an example implementation of a device 200 that is operable for selective audio streaming using the pair of linked earbuds 104A, 104B, in accordance with certain aspects of the present disclosure. In various aspects, the device 200 may have more or fewer components than illustrated in FIG. 2. In an example implementation, the device 200 may correspond to the device 106 of FIG. 1.

In an illustrative implementation, the device 200 may perform one or more operations described with reference to FIGS. 1 and 3-10. The one or more operations may include streaming the first audio 108 on the first earbud 104A and the second earbud 104B, and selectively interrupting audio streaming on one of the pair of earbuds 104A, 104B for the second audio 110 in response to receiving the audio stream event as described in the foregoing description of FIG. 1. For the sake of brevity, various operations of the device 200 are described by referring to the first audio 108, the second audio 110, the first earbud 104A, and the second earbud 104B of FIG. 1 as examples.

In many aspects, the device 200 may include one or more processor 202 (e.g., a central processing unit “CPU”). The device 200 may include one or more additional processors, for example, audio processor(s) 204. The audio processor(s) 204 may include a speech and music coder-decoder (CODEC) 206 that includes a voice coder (“vocoder”) encoder 206A and a vocoder decoder 206B. The audio processor(s) 204 and/or the speech and music CODEC 206 may include one or more audio processing components 208. These audio processing component(s) 208 may perform various functions for processing and managing audio streams for shared or individualized delivery to the pair of earbuds 104A, 104B. The audio processing component(s) 208 may perform decoding, buffering, channel allocation, and routing of the first audio 108 and the second audio 110 to the appropriate earbud based on contextual input.

In many aspects, the processor(s) 202 and the audio processor(s) 204 may be individually or collectively configured to receive an input for a selection of the second earbud 104B to stream the second audio 110. The input can correspond to a user interaction with a Graphical User Interface (GUI), a voice command, or the like. In more aspects, the processor(s) 202 and the audio processor(s) 204 may be configured to enforce one or more privacy safeguards during shared earbud usage. In an example, if the processor(s) 202 and the audio processor(s) 204 detect a shared listening context with regard to the pair of earbuds 104A, 104B, the processor(s) 202 and the audio processor(s) 204 may prevent a playback of certain sensitive or confidential second audio 110 unless an explicit override input selecting at least one preferred earbud is received. For example, if the second audio 110 corresponds to a voice note containing private banking information, a voice assistant prompt with personal data, or a confidential work message, the device 106 may restrict streaming of the second audio 110 unless an explicit input selecting at least one preferred earbud (e.g., any of the first earbud 104A or the second earbud 104B)is received. Such an override may be triggered by a recognized voice command (e.g., “Play in both earbuds” “Play in left earbud”, “Play in right earbud”) or a GUI-based confirmation on a display of the device 106.

In FIG. 2, the device 200 may include a memory 210 and a CODEC 228. The CODEC 228 may include a Digital-to-Analog Converter (DAC) 230 and Analog-to-Digital Converter (ADC) 232, which facilitate signal conversion between digital instructions and analog components. The memory 210 may include (e.g., store) instructions 212 that are executable by the one or more audio processors 204 (or the processor 202) to implement the functionality described with reference to the pair of earbuds 104A, 104B. The memory 210 may also store settings 214, which may include configuration data indicating default earbud assignment preferences for streaming the second audio 110. For example, the settings 214 may include a user-defined configuration (e.g., a user-defined rule or a customization setting) that specifies which earbud between the pair of earbuds 104A, 104B can be prioritized to stream the second audio 110 in a case the audio stream event is received at the device 200. For example, the device 200 may be configured, by a user, to route voice activity of an incoming call exclusively to the second earbud 104B as default, thereby making the second earbud 104B a prioritized earbud for incoming calls to implement the selective audio streaming functionality described with reference to FIG. 1.

In more aspects, the memory 210 may also be configured to store a media content 242. The phrase “configured to store media content” is intended to encompass various types of media content access. For example, the stored media content 242 may include content that is stored locally on the device 200, such as downloaded media or cached data residing in the memory 210. In more examples, the stored media content 242 may include content that is streamed from a remote source (e.g., via Internet from cloud-based streaming services), where at least a portion of the content may be temporarily buffered or stored in the memory 210 to facilitate playback. In other words, the term “store” may refer to both persistent storage and temporary or transient storage used to support multimedia streaming and playback. Examples of the media content 242 may include, but are not limited to, music, podcasts, audiobooks, or voice recordings.

In FIG. 2, the device 200 may also include a modem 216 coupled, via a transceiver 218, to an antenna 220. The modem 216, the transceiver 218, and the antenna 220 may enable the device 200 to exchange data with one or more devices (e.g., the pair of earbuds 104A, and 104B of FIG. 1) via wireless communications. For example, in some implementations, the device 200 may enable the streaming of the first audio 108 to each of the pair of earbuds 104A, 104B and support instructions such as exclusive streaming of the second audio 110 on a specific earbud while continuing the first audio 108 on the remaining earbud.

The device 200 may include a display 224 coupled to a display controller 226. The display 224, managed by the display controller 226, may render a GUI for audio output selection. For example, the GUI may enable a user (e.g., the second user 102B of FIG. 1) to provide the input for a selection of the second earbud 104B to stream the second audio 110. In an example, when an incoming call is received on the device 200 while two users are listening to the first audio 108 using the pair of earbuds 104A, 104B (e.g., each user wearing one earbud), the display 224 may render the GUI showing an audio output selection menu. The audio output selection menu may present a plurality of selectable options to route incoming voice activity (e.g., the second audio 110) associated with the incoming call to the first earbud 104A, the second earbud 104B, or both the first earbud 104A and the second earbud 104B. Upon receiving a selection of one of the plurality of selectable options, the processor(s) 202 and the audio processor(s) 204 may be individually or collectively configured to interrupt the ongoing stream of the first audio 108 on one or more earbuds corresponding to the selected option and stream the second audio 110 on the one or more earbuds corresponding to the selected option. For example, if the selected option corresponds to the second earbud 104B, the processor(s) 202 and the audio processor(s) 204 may stream the second audio 110 exclusively on the selected second earbud 104B, while allowing the first user 102A to listen to the first audio 108 on the first earbud 104A without interruption in parallel. In more examples, the GUI may enable a gesture-based control for a selection of an individual earbud of the pair of earbuds 104A, 104B. For example, a swipe or long-press action near an icon of an earbud may be interpreted as an assignment gesture, enabling the display 224 to support GUI-based user interaction for audio output selection.

The speaker(s) 222 and microphone(s) 234 may be coupled to the CODEC 228. In various aspects, the microphone(s) 234 may be configured to receive a voice command for a selection of the second earbud 104B for the audio stream event. For example, when the incoming call is received during media playback on the pair of earbuds 104A, 104B, the microphone(s) 234 may detect a voice command such as “Answer the call in right earbud.” The voice command input may be processed via the ADC 232, which converts an analog voice signal into a digital signal. Based on the received voice command, the second earbud 104B may be selected as the output device for the second audio 110. In several aspects, the processor(s) 202 and the audio processor(s) 204 may be configured to recognize distinct voice commands for selecting either the first earbud 104A or the second earbud 104B as the output device for the second audio 110. For example, commands such as “Answer in left earbud” or “Route to right earbud” may be interpreted by the processor(s) 202 and the audio processor(s) 204 to dynamically assign audio routing. This enables hands-free, user-directed control of selective audio streaming in shared earbud scenarios.

In an example, the speech and music CODEC 206 may provide the first audio 108 and/or the second audio 110 (in a digital format) to the CODEC 228. The CODEC 228 may convert the digital signals to analog signals using the DAC 230 and may provide the analog signals to the speaker(s) 222 for outputting. In such an example, the speakers 222 may correspond to the pair of earbuds 104A, 104B.

In an example implementation, the device 200 may include a system-in-package or system-on-chip device 240. For example, the memory 210, the processor 202, the audio processor(s) 204, the display controller 226, the CODEC 228, the modem 216, and the transceiver 218 may be included in the system-in-package or system-on-chip device 240.

In various aspects, an input device 236 and a power supply 238 may be coupled to the system-in-package or the system-on-chip device 240. The input device 236 may be a capacitive touchscreen, gesture sensor, physical button, or voice input module. The input device 236 may enable the users to interact with notifications and audio controls, including accepting or rejecting calls, modifying volume, or selecting audio output destinations. For example, upon receiving an incoming call, the processor(s) 202 and the audio processor(s) 204 may prompt the user to assign the incoming call to either the first earbud 104A, the second earbud 104B, or both. Moreover, in an example implementation, as illustrated in FIG. 2, the display 224, the input device 236, the speaker(s) 222, the microphone(s) 234, the antenna 220, and the power supply 238 may be external to the system-in-package or the system-on-chip device 240. Each of the display 224, the input device 236, the speaker(s) 222, the microphone(s) 234, the antenna 220, and the power supply 238 may be coupled to a component of the system-in-package or the system-on-chip device 240 such as an interface or a controller.

The device 200 may include a wearable device, such as a wearable mobile communication device, a wearable personal digital assistant, a wearable gaming system, a wearable music player, a wearable radio, a wearable navigation device, a headset, an augmented reality headset, a mixed reality headset, a virtual reality headset, a voice-activated device, a portable electronic device, a wearable computing device, a wearable communication device, a virtual reality (VR) device, one or more earbuds, a hearing aid device, or any combination thereof.

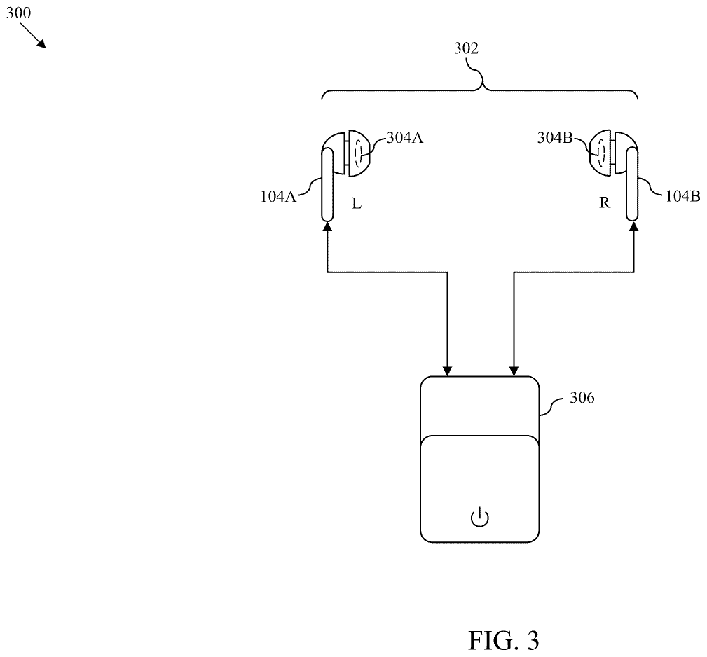

FIG. 3 is a block diagram 300 that illustrates a pair of earbuds 302 and a charging case 306, in accordance with certain aspects of the present disclosure. FIG. 3 is described in conjunction with FIGS. 1 and 2. The pair of earbuds 302 may be similar to the pair of earbuds 104A, 104B shown in FIG. 1. The pair of earbuds 302 is shown to include the first earbud 104A and the second earbud 104B. Each of the pair of earbuds 302 respectively includes a speaker. For example, the first earbud 104A includes a first speaker 304A and the second earbud 104B includes a second speaker 304B. The first earbud 104A and the second earbud 104B are configured to operate either in a synchronized or shared audio delivery mode (receiving the first audio 108) or in an independent or private audio delivery mode where each earbud may receive distinct audio streams, such as the stream of the first audio 108 (e.g., music) on the first earbud 104A and the stream of the second audio 110 (e.g., an incoming call) on the second earbud 104B as described in the foregoing description of FIG. 1.

In various aspects, the pair of earbuds 302 may be operatively coupled to the charging case 306. The charging case 306 may be configured to provide power to the pair of earbuds 302 when the pair of earbuds 302 are docked in the charging case 306. In various aspects, the charging case 306 may be configured to manage communication between the pair of earbuds 302 and an external device (e.g., a smartphone). For example, when the first earbud 104A and the second earbud 104B are placed inside the charging case 306, the charging case 306 may supply power to charge batteries of the pair of earbuds 302. Simultaneously, the charging case 306 may act as a communication bridge between the pair of earbuds 302 and a paired smartphone by managing wireless (e.g., Bluetooth®) connectivity. For example, when the pair of earbuds 302 are docked, the charging case 306 can indicate to the smartphone regarding an unavailability of the pair of earbuds 302. Once the user removes either earbud (e.g., the second earbud 104B) from the charging case 306, the charging case 306 may indicate to the smartphone regarding a change in the availability status of removed earbud.

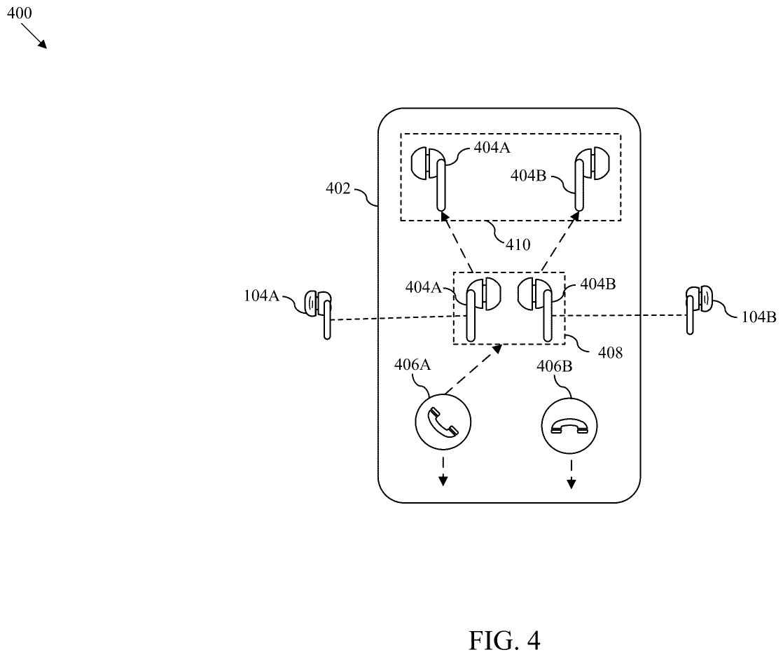

FIG. 4 is a block diagram that illustrates a GUI 402 rendered on a display 400 of a device for gesture-based control, in accordance with certain aspects of the present disclosure. FIG. 4 is described in conjunction with FIG. 1-3. In various aspects, the GUI 402 rendered on the display 400 may include fewer or more icons or objects than illustrated in FIG. 4. In an example implementation, the device may correspond to the device 200 of FIG. 2, or the device 106 of FIG. 1, and the display 400 can correspond to the display 224 of FIG. 2.

In various aspects, the GUI 402 may be configured to enable a gesture-based control for selective audio streaming in a dual earbud setup or configuration. As shown in FIG. 4, the GUI 402 includes icon representations corresponding to a pair of earbuds wirelessly coupled to the device. The icon representations include a first icon 404A corresponding to the first earbud 104A and a second icon 404B corresponding to the second earbud 104B. The first earbud 104A and the second earbud 104B may correspond to linked wireless earbuds as described in the foregoing description of FIG. 1. The GUI 402 may provide a visual interface that enables a user to selectively control the routing of audio streams, including the first audio 108 and the second audio 110 of FIG. 1, to individual earbuds from the pair of earbuds 104A, 104B.

In various aspects, one or more processors (e.g., the processor(s) 202 or the audio processor(s) 204) of the device, coupled to the pair of earbuds 104A, 104B, may be configured to render the GUI 402 on the display 400 and receive an input corresponding to a selection of one or more earbuds vis GUI icons (such as the first icon 404A corresponding to the first earbud 104A, the second icon 404B corresponding to the second earbud 104B, or both). For example, when an incoming call (e.g., the second audio 110) is received during media playback on the device, the GUI 402 may render the first icon 404A and the second icon 404B for the first earbud 104A and the second earbud 104B, respectively. A selection of one of the first icon 404A or the second icon 404B can be made by the user to designate the corresponding earbud (e.g., the first earbud 104A or the second earbud 104B) as a target output device for the second audio 110.

Upon receiving the input, the one or more processors of the device may interrupt the stream of the first audio 108 on the selected earbud and begin streaming the second audio 110 exclusively on the selected earbud, while the unselected earbud may continue to stream the first audio 108 without interruption.

In various implementations, the GUI 402 may be rendered dynamically in response to receiving or detecting the audio stream event. The GUI 402 may enable multiple gesture types, including swipe gestures in configured directions and tap gestures. Swipe gestures or tap gestures can be performed on the GUI 402 via the display 400 to indicate a selection of a preferred earbud for receiving the second audio 110 associated with the audio stream event. For example, a first swipe gesture directed in a top-left direction toward the first icon 404A on the GUI 402 may be interpreted as a selection of the first earbud 104A for receiving the second audio 110. Similarly, a second swipe gesture directed in a top-right direction toward the second icon 404B on the GUI 402 may be interpreted as a selection of the second earbud 104B for receiving the second audio 110.

In additional aspects, the GUI 402 may include a call control section including additional icons 406A and 406B representing call response actions. For example, a third icon 406A may correspond to an “accept call” action, while a fourth icon 406B may correspond to a “reject call” action. Interaction (e.g., swipe, tap, tap-and-hold gestures) with the third icon 406A and the fourth icon 406B may enable a user to respond to incoming calls. For example, a swipe-down gesture performed after selection of the third icon 406A may result in the device routing the second audio 110 associated with the incoming call to a local speaker, such as the speaker 222 of the device 200 shown in FIG. 2. A swipe-down gesture performed after selection of the fourth icon 406B may result in termination of the audio stream event, thereby rejecting the incoming call.

In more examples, a tap-and-hold input on the third icon 406A, maintained for a defined duration (e.g., 100 milliseconds, one second, or the like), may cause the GUI 402 to render a secondary interface 408 that visually presents a combined representation of the pair of earbuds 104A, 104B. From this state (e.g., the secondary interface 408 being rendered), a swipe gesture originating at the third icon 406A and directed toward the secondary interface 408 may be interpreted as a selection of both the first earbud 104A and the second earbud 104B for receiving the second audio 110. Alternatively, when the swipe gesture pauses briefly at the location of the secondary interface 408, the GUI 402 may transition to a tertiary interface 410. In this tertiary interface 410, the first earbud 104A and the second earbud 104B may be presented as separate selectable options via the first icon 404A and the second icon 404B, respectively. The first icon 404A may be positioned, for example, in a top-left region of the GUI 402 and the second icon 404B positioned, for example, in a top-right region of the GUI 402, in the tertiary interface 410. The swipe gesture may then be continued from the secondary interface 408 toward one of the top-left region (e.g., toward the first icon 404A in the top-left region) or the top-right region (e.g., toward the second icon 404B in the top-right region) to select the corresponding earbud for exclusive delivery of the second audio 110. If the swipe gesture is completed without diverting to the top-left region or the top-right region, the device may proceed to stream the second audio 110 to the first earbud 104A and the second earbud 104B in parallel based on the selection of the combined representation in the secondary interface 408. In FIG. 4, swipe gesture options are represented as dashed arrows.

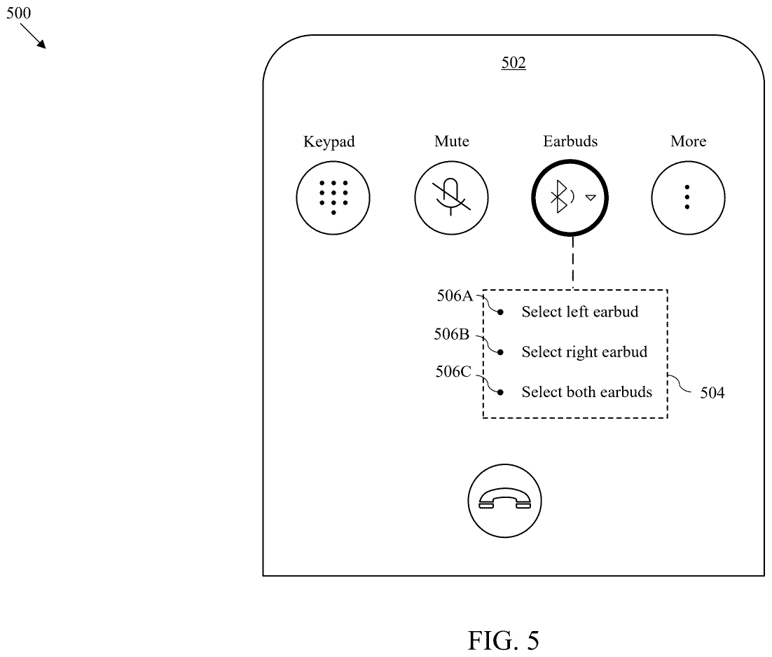

FIG. 5 is a block diagram that illustrates a GUI 502 rendered on a display 500 of a device to present an audio output selection menu for selective audio streaming, in accordance with certain aspects of the present disclosure. FIG. 5 is described in conjunction with FIG. 1-4. In various aspects, the GUI 502 rendered on the display 500 may include fewer or more icons or objects than illustrated in FIG. 5. In an example implementation, the device may correspond to the device of FIG. 4, the device 200 of FIG. 2, or the device 106 of FIG. 1.

In various aspects, the GUI 502 may represent a visual interface configured to enable selection of an audio output path related to the second audio 110 while an audio stream event, such as a call, is in progress. In many aspects, the GUI 502 may include an “Earbuds” icon, which may be associated with a selectable control for routing the second audio 110. Upon selection of the Earbuds icon, an audio output selection menu 504 may be rendered. The audio output selection menu 504 may provide a plurality of selectable options for the audio stream event. The plurality of selectable options may include a first selectable option 506A, a second selectable option 506B, and a third selectable option 506C for assignment of the second audio 110 to a left earbud, a right earbud, or both earbuds. The earbuds referenced in the GUI 502 may correspond to the pair of earbuds 302 shown in FIG. 3 or the pair of earbuds 104A, 104B shown in FIG. 1. For example, the first selectable option 506A (“Select left earbud”) may exclusively correspond to a selection of the first earbud 104A for the audio stream event. The second selectable option 506B (“Select right earbud”) may exclusively correspond to a selection of the second earbud 104B for the audio stream event. Likewise, the third selectable option 506C (“Select both earbuds”) may correspond to a selection of the first earbud 104A and the second earbud 104B for the audio stream event. Based on the audio output selection menu 504, a selection may be made to choose which earbud(s) can receive the second audio 110 (e.g., call audio). The pair of earbuds may correspond to the pair of earbuds 302 of FIG. 3, or the pair of earbuds 104A, 104B of FIG. 1.

Based on a selection input on the GUI 502, one or more processors (e.g., the processor(s) 202 or the audio processor(s) 204) of the device may be configured to stream the second audio 110. For example, if the first selectable option 506A “Select left earbud” is selected, the second audio 110 (e.g., voice activity of the call) may be streamed exclusively to the first earbud 104A, while the first audio 108 (e.g., music or media content) may continue to be streamed to the second earbud 104B without interruption. Likewise, if the second selectable option 506B “Select right earbud” is selected, the second audio 110 (e.g., voice activity of the call) may be streamed exclusively to the second earbud 104B, while the first audio 108 (e.g., music or media content) may continue to be streamed to the first earbud 104A without interruption. However, if the third selectable option 506C “Select both earbuds” is selected, the second audio 110 (e.g., voice activity of the call) may be streamed on the first earbud 104A and the second earbud 104B.

In various aspects, the GUI 502 may also include in-call functions such as Keypad, Mute, Earbuds, and More, allowing the user to interact with the call session while simultaneously configuring their earbud audio preferences.

In various aspects, while the second earbud 104B may initially be selected to output the second audio 110, the GUI 502 may provide the audio output selection menu 504 to enable dynamic reassignment of the second audio 110 during an ongoing audio stream event, such as the call. For example, during the call session, a selection using the first selectable option 506A may be made from the audio output selection menu 504 to reassign the second audio 110 from the second earbud 104B to the first earbud 104A. In response to such a selection, the one or more processors may be configured to transfer the stream of the second audio 110 exclusively to the first earbud 104A from the second earbud 104B, provided that both the first earbud 104A and the second earbud 104B are worn. This reassignment may occur without interrupting the active call session, enabling flexible and context-driven audio routing during shared earbud usage. Additionally, if during the call session, a selection using the third selectable option 506C is made, the one or more processors may be configured to transfer and stream the second audio 110 concurrently to both the first earbud 104A and the second earbud 104B. These reassignments may occur without interrupting the active call session, enabling flexible and context-driven audio routing during shared earbud usage.

Although FIG. 5 describes the GUI 502 for selecting the audio output path during an active audio stream event, the scope of the disclosure is not limited to the illustrated implementation and may extend to other interface contexts, including but not limited to notification bar controls, voice command inputs, or gesture-based overlays. In an example, a notification bar interface may be rendered on the display 500 for enabling audio routing control for the second audio 110. The notification bar may present selectable options to assign the second audio 110 to the first earbud 104A, the second earbud 104B, or both. Upon selection, the one or more processors may update the audio output path accordingly without requiring the user to navigate away from a current UI. Such notification bar may enable quick, context-aware selection of audio output directly from notification area of the device.

In more examples, a pop-up notification that prompts the user to select a preferred earbud for receiving the second audio 110 may be presented on the display 500 in response to receiving the audio stream event. The pop-up may include selectable options for assigning the second audio 110 to the first earbud 104A, the second earbud 104B, or both.

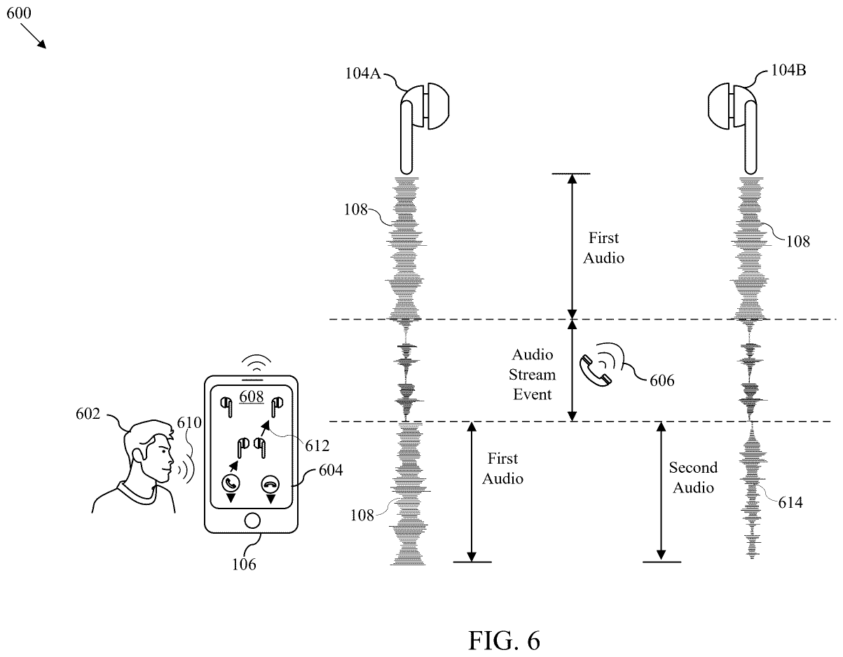

FIG. 6 is a diagram that illustrates an example scenario 600 depicting selective audio streaming in a dual earbud setup, in accordance with certain aspects of the present disclosure. FIG. 6 is described in conjunction with FIG. 1-5. As shown, the example scenario 600 depicts the first earbud 104A and the second earbud 104B. The example scenario 600 also depicts a user 602 in proximity to the device 106, which may be communicatively coupled to the first earbud 104A and the second earbud 104B. The device 106 may include a display 604.

The device 106 may be configured to stream the first audio 108 (e.g., music or a podcast) to both the first earbud 104A and the second earbud 104B in synchronization. While the first earbud 104A and the second earbud 104B are outputting the first audio 108 in synchronization, the device 106 may receive an incoming call 606 (e.g., an audio stream event). In response to receiving the incoming call 606, the device 106 may render a GUI 608 on the display 604. The GUI 608 may present an interactive control interface (e.g., a gesture-based control interface), including icons or selection regions that allow for individual earbud selection for answering the incoming call 606. Input for a selection of a target earbud for answering the incoming call 606 may be received via either a voice command 610 (“Answer the call in right earbud”) issued by the user 602 or a swipe gesture 612 in a configured direction performed by the user 602 on the GUI 608. In the example shown in FIG. 6, the device 106 receives the input for a selection of the second earbud 104B to stream the second audio 110 (e.g., incoming voice activity) associated with incoming call 606.

In response, the device 106 may interrupt the stream of the first audio 108 on the second earbud 104B and stream the second audio 110 exclusively on the second earbud 104B. The first earbud 104A may continue receiving and outputting the first audio 108 without interruption. Such selective streaming of the second audio 110 (such as the incoming voice activity of the call) exclusively to a single earbud (e.g., the first earbud 104A or the second earbud 104B) enhances user privacy and comfort, particularly in shared earbud scenarios where each person is wearing one earbud.

The GUI 608 may also include visual feedback indicating which earbud is currently active for the call 606, allowing the user 602 to quickly confirm or adjust the output destination. In some implementations, the GUI 608 could further present options to transfer the call to the remaining earbud or enable both earbuds for dual-audio. Such flexibility may be useful in dynamic environments, such as during workouts, shared commuting, collaborative workspaces, or the like.

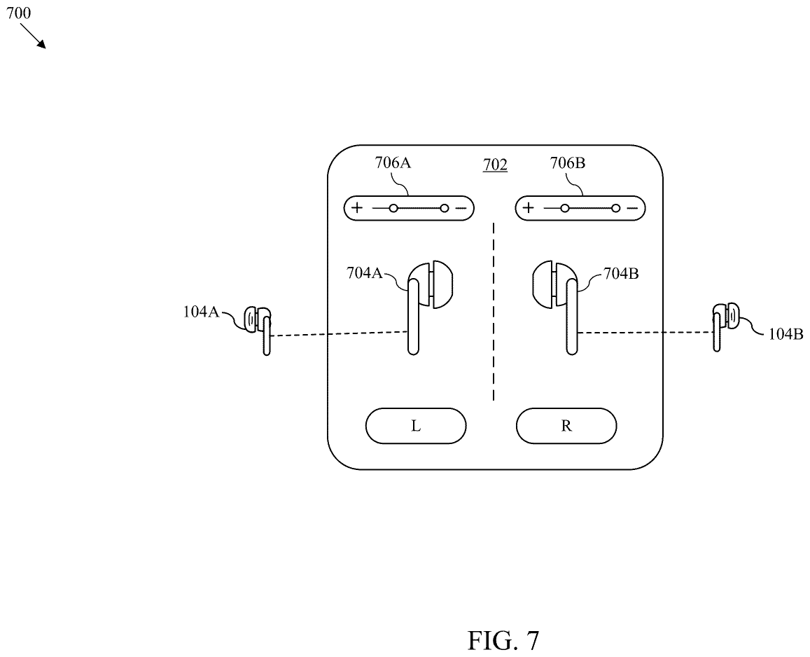

FIG. 7 is a block diagram that illustrates a GUI 702 rendered on a display 700 of a device for volume control, in accordance with certain aspects of the present disclosure. FIG. 7 is described in conjunction with FIG. 1-6. In various aspects, the GUI 702 may include fewer or more icons or objects than illustrated in FIG. 7. As shown in FIG. 7, the GUI 702 may include icon representations corresponding to a pair of earbuds wirelessly coupled to the device. The icon representations include a first icon 704A corresponding to the first earbud 104A and a second icon 704B corresponding to the second earbud 104B. The first earbud 104A and the second earbud 104B may correspond to linked wireless earbuds as described in the foregoing description of FIG. 1. In various aspects, one or more processors (e.g., the processor(s) 202 or the audio processor(s) 204) of the device may be individually or collectively configured to enable an independent volume control on each of the first earbud 104A and the second earbud 104B via the GUI 702.

In various aspects, the first icon 704A and the second icon 704B may be visually represented alongside a corresponding volume slider control, for example, a first volume slider 706A represented alongside the first icon 704A and a second volume slider 706B represented alongside the second icon 704B. The first volume slider 706A and the second volume slider 706B may be used for controlling volumes of the first earbud 104A and the second earbud 104B, respectively.

In an example scenario, during a shared listening session, two users may each wear one earbud, for example, user A wears the first earbud 104A and user B wears the second earbud 104B. In such a scenario, the one or more processors may receive a user input to modify a volume of the second earbud 104B from a first level to a second level. For example, the user B may adjust the second volume slider 706B to a higher level. In response, the one or more processors may exclusively modify the volume of the second earbud 104B based on the received input while both the first earbud 104A and the second earbud 104B are worn. Thus, an audio output level (e.g., the volume) in the second earbud 104B is modified without affecting a volume level in the first earbud 104A. Similarly, adjusting the first volume slider 706A may increase or decrease the volume of the first earbud 104A without impacting the second earbud 104B.

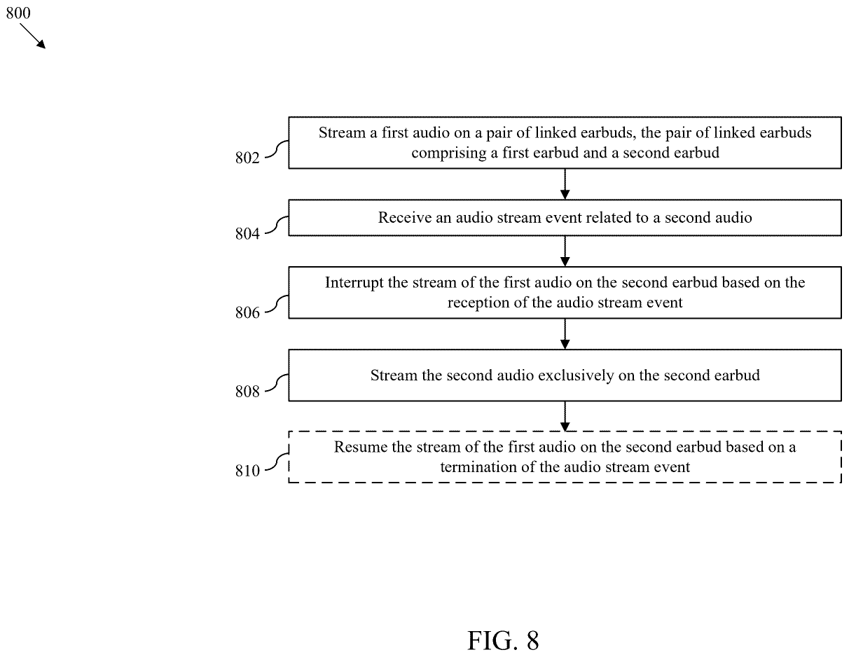

FIG. 8 is a flowchart that illustrates a method (e.g., a process) for selective audio streaming in a dual earbud setup, in accordance with certain aspects of the present disclosure. FIG. 8 is described in conjunction with FIG. 1-7. Referring to FIG. 8, there is shown a process 800 that illustrates various operations 802 through 810 for selective audio streaming in a dual earbud setup. In a non-limiting example, the process 800 is explained with reference to the first earbud 104A and the second earbud 104B, which correspond to the pair of linked earbuds 302 that are physically unconnected and independently wearable as described in the foregoing description of FIG. 1-7. Further, in a non-limiting example, the process 800 is explained with reference to the processor(s) 202 and the device 200 of FIG. 2. In various aspects, the device 200 may have a capability to selectively stream audio in a dual earbud setup.

At 802, a first audio may be streamed on the pair of linked earbuds 302. The pair of linked earbuds 302 may comprise the first earbud 104A and the second earbud 104B. For example, the processor(s) 202 may be individually or collectively configured to stream the first audio 108 associated with a media content on the pair of linked earbuds 302. In an example, the first audio 108 may include music, a podcast, or similar audio media that is streamed synchronously to both the first earbud 104A and the second earbud 104B. In an example, the streaming process may involve transmitting encoded digital audio packets associated with the media content over a wireless communication link (e.g., Bluetooth®). For the first audio 108, the processor(s) 202 may stream compressed audio frames or segments formatted according to a codec and arranged for stereo or mono playback.

At 804, an audio stream event related to a second audio may be received. For example, the processor(s) 202 may be individually or collectively configured to receive the audio stream event related to the second audio 110. In a non-limiting example, the audio stream event may correspond to an incoming call (the incoming call 606 described in FIG. 6), a voice assistant response, or any similar system-generated audio prompt.

At 806, the stream of the first audio 108 on the second earbud 104B may be interrupted based on the reception of the audio stream event. For example, the processor(s) 202 may be individually or collectively configured to interrupt the stream of the first audio 108 on the second earbud 104B based on the reception of the audio stream event.

At 808, the second audio 110 may be streamed exclusively on the second earbud 104B. For example, the processor(s) 202 may be individually or collectively configured to stream the second audio 110 exclusively on the second earbud 104B. In an example, the second audio 110 may include an incoming voice activity associated with the incoming call. In many aspects, the processor(s) 202 may concurrently stream the first audio 108 on the first earbud 104A and the second audio 110 on the second earbud 104B. In more aspects, the processor(s) 202 may stream the second audio 110 exclusively on the second earbud 104B while the second earbud 104B and the first earbud 104A are worn. In such a scenario, the first earbud 104A may or may not output the first audio 108. In more examples, the processor(s) 202 may stream the second audio 110 on the second earbud 104B based on a configuration that identifies the second earbud 104B as prioritized over the first earbud 104A to answer an incoming call (e.g., the received audio stream event). When streaming the second audio 110, such as an incoming call or voice prompt, the processor(s) 202 may transmit voice-optimized encoded packets (e.g., using a vocoder) that represent the live or buffered voice activity.

At 810, the stream of the first audio 108 may be resumed on the second earbud 104B based on a termination of the audio stream event. For example, the processor(s) 202 may be individually or collectively configured to resume the stream of the first audio 108 on the second earbud 104B based on the termination of the audio stream event. The one or more processors may detect when the audio stream event has terminated (e.g., the call has ended or been declined) and automatically resume playback of the previously interrupted first audio 108 on the second earbud 104B. In some aspects, resuming the stream of the first audio 108 on the second earbud 104B based on the termination of the audio stream event may be optional.

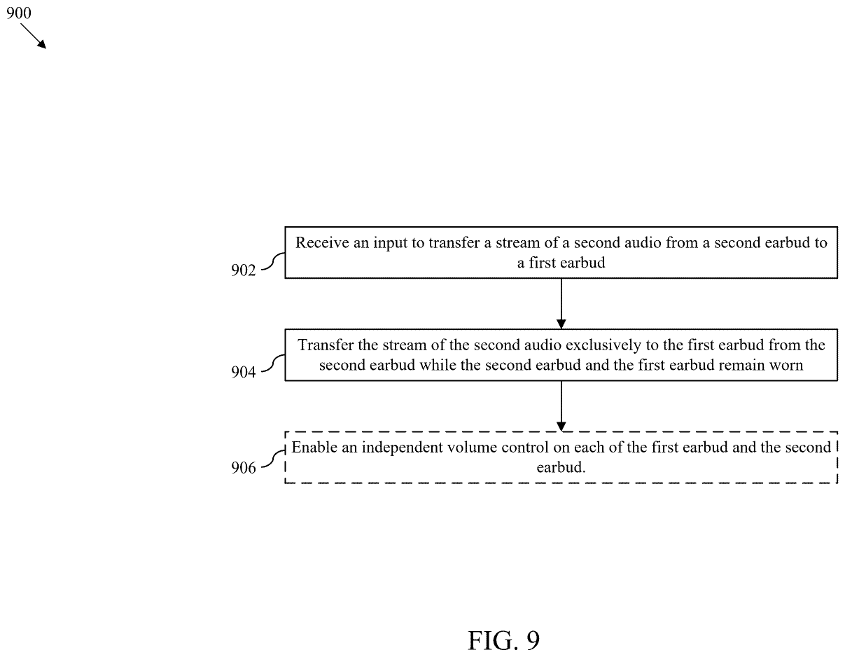

FIG. 9 is a flowchart that illustrates a method (e.g., a process) for managing selective audio streaming in a dual earbud setup, in accordance with certain aspects of the present disclosure. FIG. 9 is described in conjunction with FIG. 1-8. Referring to FIG. 9, there is shown a process 900 that illustrates various operations 902 through 906 managing selective audio streaming in a dual earbud setup. In a non-limiting example, the process 900 is explained with reference to the first earbud 104A and the second earbud 104B, which correspond to the pair of linked earbuds 302 that are physically unconnected and independently wearable as described in the foregoing description of FIG. 1-8. Further, in a non-limiting example, the process 900 is explained with reference to the processor(s) 202 and the device 200 of FIG. 2. In various aspects, the device 200 may have a capability to selectively stream audio in a dual earbud setup. In a non-limiting example, it is assumed that the first earbud 104A and the second earbud 104B are concurrently outputting distinct audios (e.g., the first audio 108 and the second audio 110, respectively) without temporal synchronization.

At 902, an input may be received to transfer a stream of the second audio 110 from the second earbud 104B to the first earbud 104A. For example, the processor(s) 202 may be individually or collectively configured to receive the input to transfer the stream of the second audio 110 from the second earbud 104B to the first earbud 104A. The input may be received through a user interaction with a GUI (e.g., a GUI tap, swipe gesture, or menu selection) or via a voice command as described in the foregoing description of FIG. 4-6. The input can also be received through a system device level interrupt. For example, if a battery level associated with the second earbud 104B falls below a defined threshold during an ongoing audio stream event, and the second audio 110 corresponds to a time-sensitive or high-priority voice call, the processor(s) 202 may receive the input. In more examples, the processor(s) 202 may receive the input in a scenario where the users sharing the pair of linked earbuds 302 intend to exchange the first earbud 104A and the second earbud 104B.

At 904, the stream of the second audio 110 may be transferred exclusively to the first earbud 104A from the second earbud 104B while the second earbud 104B and the first earbud 104A remain worn. For example, the processor(s) 202 may be individually or collectively configured to transfer the stream of the second audio 110 exclusively to the first earbud 104A from the second earbud 104B, while the second earbud 104B and the first earbud 104A remain worn.

At 906, an independent volume control may be enabled on each of the first earbud 104A and the second earbud 104B. For example, the processor(s) 202 may be individually or collectively configured to enable an independent volume control on each of the first earbud 104A and the second earbud 104B as described in the foregoing description of FIG. 7.

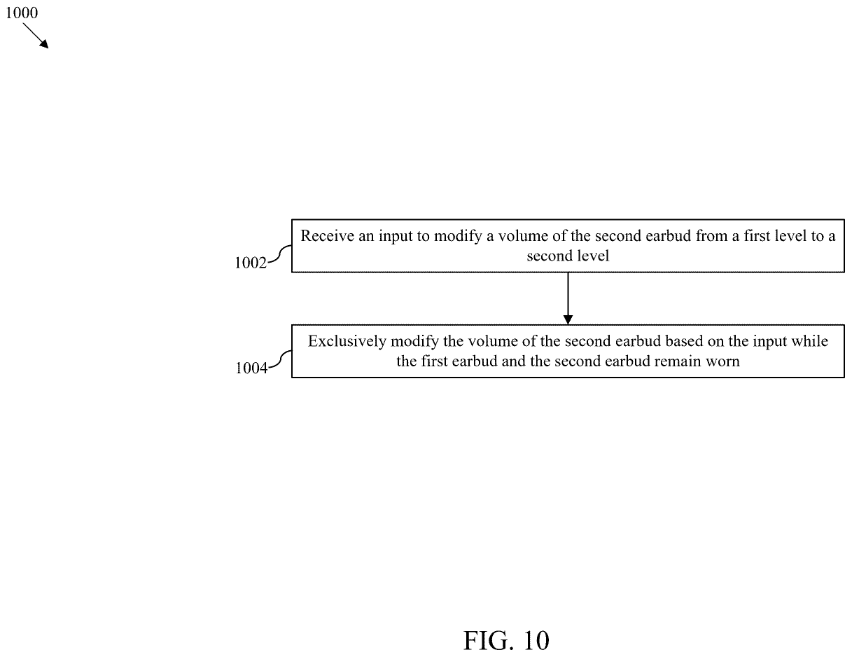

FIG. 10 is a flowchart that illustrates a method (e.g., a process) for managing independent volume control on a pair of linked earbuds, in accordance with certain aspects of the present disclosure. FIG. 10 is described in conjunction with FIG. 1-9. Referring to FIG. 10, there is shown a process 1000 that illustrates various operations 1002 through 1004 for managing independent volume control on the pair of linked earbuds. In a non-limiting example, the process 1000 is explained with reference to the first earbud 104A and the second earbud 104B, which correspond to the pair of linked earbuds 302 that are physically unconnected and independently wearable as described in the foregoing description of FIG. 1-9. Further, in a non-limiting example, the process 1000 is explained with reference to the processor(s) 202 and the device 200 of FIG. 2. In various aspects, the device 200 may have a capability to selectively stream audio in a dual earbud setup. In a non-limiting example, it is assumed that the pair of linked earbuds 302 is being shared between two users.

At 1002, an input may be received to modify a volume of the second earbud 104B from a first level to a second level. For example, the processor(s) 202 may be individually or collectively configured to receive the input to modify the volume of the second earbud 104B from the first level to the second level. The input may be received through a GUI, a touch gesture, a physical button, or a voice command. The modification of volume can correspond to an increase in volume or a decrease in volume.

At 1004, the volume of the second earbud 104B may be exclusively modified based on the input while the first earbud 104A and the second earbud 104B remain worn. For example, the processor(s) 202 may be individually or collectively configured to exclusively modify the volume of the second earbud 104B based on the input as described in the foregoing description of FIG. 7. In this operation, only the volume of the second earbud 104B is affected by the adjustment, and the first earbud 104A continues outputting the first audio 108 at the previously set volume level without interruption or modification.

Some implementation examples are described in the following numbered aspects:
Aspect 1: A method for selective audio streaming to a pair of linked earbuds is disclosed. The method comprising streaming a first audio on the pair of linked earbuds, the pair of linked earbuds comprising a first earbud and a second earbud. The method comprising receiving an audio stream event related to a second audio. The method comprising interrupting the streaming of the first audio on the second earbud based on the reception of the audio stream event. The method comprising streaming the second audio exclusively on the second earbud.
Aspect 2: The method of aspect 1, comprising concurrently streaming the first audio on the first earbud and the second audio on the second earbud.
Aspect 3: The method of any of aspects 1 through 2, comprising streaming the second audio exclusively on the second earbud while the second earbud and the first earbud are worn.
Aspect 4: The method of any of aspects 1 through 3, comprising resuming the stream of the first audio on the second earbud based on a termination of the audio stream event.
Aspect 5: The method of any of aspects 1 through 4, comprising receiving an input for a selection of the second earbud to stream the second audio.
Aspect 6: The method of aspect 5, wherein the received input corresponds to a user interaction with a Graphical User Interface (GUI).
Aspect 7: The method of aspect 5, wherein the received input corresponds to a voice command.
Aspect 8: The method of any of aspects 1 through 7, comprising rendering a Graphical User Interface (GUI) on a display that enables a gesture-based control for a selection of an individual earbud of the pair of linked earbuds.
Aspect 9: The method of aspect 8, comprising streaming the second audio exclusively on the second earbud based on a swipe gesture in a configured direction on the GUI.
Aspect 10: The method of any of aspects 1 through 9, comprising rendering an audio output selection menu on a display that provides a plurality of selectable options for the audio stream event, wherein a first selectable option of the plurality of selectable options exclusively corresponds to a selection of the first earbud for the audio stream event, and a second selectable option of the plurality of selectable options exclusively corresponds to a selection of the second earbud for the audio stream event.
Aspect 11: The method of aspect 10, comprising streaming the second audio exclusively on the second earbud based on a selection of the second selectable option.
Aspect 12: The method of any of aspects 1 through 11, comprising receiving a voice command from a microphone for a selection of the second earbud for the audio stream event.
Aspect 13: The method of aspect 12, comprising streaming the second audio exclusively on the second earbud based on the voice command.
Aspect 14: The method of any of aspects 1 through 13, comprising receiving an input to transfer the stream of the second audio from the second earbud to the first earbud; and transferring the stream of the second audio exclusively to the first earbud from the second earbud while the second earbud and the first earbud are worn.
Aspect 15: The method of any of aspects 1 through 14, comprising enabling an independent volume control on each of the first earbud and the second earbud.
Aspect 16: The method of any of aspects 1 through 15, comprising receiving an input to modify a volume of the second earbud from a first level to a second level; and exclusively modifying the volume of the second earbud based on the input while the first earbud and the second earbud are worn.
Aspect 17: The method of any of aspects 1 through 16, wherein the audio stream event corresponds to an incoming call and the second audio corresponds to an incoming voice activity associated with the incoming call.
Aspect 18: The method of aspect 17, comprising streaming the second audio on the second earbud based on a configuration that identifies the second earbud as prioritized over the first earbud to answer the incoming call.
Aspect 19: A method for selective audio streaming to a pair of linked earbuds is disclosed. The method comprising streaming a first audio on the pair of linked earbuds, the pair of linked earbuds comprising a first earbud and a second earbud. The method comprising receiving an audio stream event related to a second audio. The method comprising interrupting the streaming of the first audio on the second earbud based on the reception of the audio stream event. The method comprising streaming the second audio exclusively on the second earbud while the first earbud and the second earbud are worn.
Aspect 20: A device comprising one or more memories; and one or more processors coupled to the one or more memories, the one or more processors individually or collectively configured to cause the device to perform a method of any of aspects 1 through 19.
Aspect 21: A device comprising at least one means for performing a method of any of aspects 1 through 19.
Aspect 22: A non-transitory computer-readable medium storing code for selective audio streaming at a device, the code comprising instructions executable by a processor to perform a method of any of aspects 1 through 19.
Aspect 23: An audio output device comprising a pair of linked earbuds comprising a first earbud and a second earbud. The first earbud is configured to receive a first audio and output the first audio. The second earbud is configured to receive the first audio as received at the first earbud; output the first audio in synchronization with the output of the first audio from the first earbud; receive a second audio; and output the second audio in parallel to the output of the first audio from the first earbud.

It should be noted that the methods described herein describe possible implementations, and that the operations and the steps may be rearranged or otherwise modified and that other implementations are possible. Further, aspects from two or more of the methods may be combined.

As used herein, the phrase ‘one or more processors individually or collectively configured to’ may encompass various aspects, including but not limited to: processors that are programmed and capable of performing the function, regardless of whether execution is occurring at a given time; processors actively executing instructions to perform the function; and processors that, when triggered by an event or condition, initiate execution of the function. This phrase does not limit the scope of the disclosure to an actively functioning device.

As used herein, the phrase ‘one or more processors individually or collectively configured to’ may encompass various aspects, including but not limited to: a single processor executing all functions; multiple processors, each performing different aspects of the function independently; multiple processors operating in coordination to execute a function collectively; or any combination thereof, where different processors may dynamically (e.g., concurrently or sequentially) assume responsibilities based on system conditions.

It is understood that the specific order or hierarchy of steps in the processes disclosed is an illustration of example approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various illustrative blocks and components described in connection with the disclosure herein may be implemented or performed using a general-purpose processor, a Digital Signal Processor (DSP), an Application-Specific Integrated Circuit (ASIC), a Central Processing Unit (CPU), a Field-Programmable Gate Array (FPGA), or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to a different location. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disks and discs, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. A device, comprising:
one or more memories configured to store a media content; and
one or more processors coupled to the one or more memories, the one or more processors individually or collectively configured to:
stream a first audio associated with the media content on a pair of linked earbuds, the pair of linked earbuds comprising a first earbud and a second earbud;
receive an audio stream event related to a second audio;
interrupt the stream of the first audio on the second earbud based on the reception of the audio stream event; and
stream the second audio exclusively on the second earbud.

2. The device of claim 1, wherein the one or more processors individually or collectively are configured to concurrently stream the first audio on the first earbud and the second audio on the second earbud.

3. The device of claim 1, wherein the one or more processors individually or collectively are configured to stream the second audio exclusively on the second earbud while the second earbud and the first earbud are worn.

4. The device of claim 1, wherein the one or more processors individually or collectively are configured to resume the stream of the first audio on the second earbud based on a termination of the audio stream event.

5. The device of claim 1, wherein the one or more processors individually or collectively are configured to receive an input for a selection of the second earbud to stream the second audio.

6. The device of claim 5, wherein the received input corresponds to a user interaction with a Graphical User Interface (GUI).

7. The device of claim 5, wherein the received input corresponds to a voice command.

8. The device of claim 1, comprising a display configured to render a Graphical User Interface (GUI) that enables a gesture-based control for a selection of an individual earbud of the pair of linked earbuds.

9. The device of claim 8, wherein the one or more processors individually or collectively are configured to stream the second audio exclusively on the second earbud based on a swipe gesture in a configured direction on the GUI.

10. The device of claim 1, comprising a display configured to render an audio output selection menu that provides a plurality of selectable options for the audio stream event, wherein
a first selectable option of the plurality of selectable options exclusively corresponds to a selection of the first earbud for the audio stream event, and
a second selectable option of the plurality of selectable options exclusively corresponds to a selection of the second earbud for the audio stream event.

11. The device of claim 10, wherein the one or more processors individually or collectively are configured to stream the second audio exclusively on the second earbud based on a selection of the second selectable option.

12. The device of claim 1, comprising a microphone configured to receive a voice command for a selection of the second earbud for the audio stream event.

13. The device of claim 12, wherein the one or more processors individually or collectively are configured to stream the second audio exclusively on the second earbud based on the voice command.

14. The device of claim 1, wherein the one or more processors individually or collectively are configured to:
receive an input to transfer the stream of the second audio from the second earbud to the first earbud; and
transfer the stream of the second audio exclusively to the first earbud from the second earbud while the second earbud and the first earbud are worn.

15. The device of claim 1, wherein the one or more processors individually or collectively are configured to enable an independent volume control on each of the first earbud and the second earbud.

16. The device of claim 1, wherein the one or more processors individually or collectively are configured to:
receive an input to modify a volume of the second earbud from a first level to a second level; and
exclusively modify the volume of the second earbud based on the input while the first earbud and the second earbud are worn.

17. The device of claim 1, wherein the audio stream event corresponds to an incoming call and the second audio corresponds to an incoming voice activity associated with the incoming call.

18. The device of claim 17, wherein the one or more processors individually or collectively are configured to stream the second audio on the second earbud based on a configuration that identifies the second earbud as prioritized over the first earbud to answer the incoming call.

19. An audio output device, comprising:
a pair of linked earbuds comprising a first earbud and a second earbud, wherein
the first earbud is configured to:
receive a first audio; and
output the first audio, and
the second earbud is configured to:
receive the first audio as received at the first earbud;
output the first audio in synchronization with the output of the first audio from the first earbud;
receive a second audio; and
output the second audio in parallel to the output of the first audio from the first earbud.

20. A method for audio playback, the method comprising:
streaming a first audio on a pair of linked earbuds, the pair of linked earbuds comprising a first earbud and a second earbud;
receiving an audio stream event related to a second audio;
interrupting the streaming of the first audio on the second earbud based on the reception of the audio stream event; and
streaming the second audio exclusively on the second earbud while the first earbud and the second earbud are worn.
